(19) United States
(12) Patent Application Publication
(10) Pub. No.: US 2020/0211202 A1
(43) Pub. Date: Jul. 2, 2020

(54) FALL DETECTION METHOD, FALL DETECTION APPARATUS AND ELECTRONIC DEVICE

(71) Applicant: Fujitsu Limited, Kawasaki-shi (JP)

(72) Inventors: Zongyan ZHANG, Beijing (CN); Qi WANG, Beijing (CN)

(73) Assignee: Fujitsu Limited, Kawasaki-shi (JP)

(21) Appl. No.: 16/725,154

(22) Filed: Dec. 23, 2019

(30) Foreign Application Priority Data
Dec. 28, 2018 (CN) 201811621796.7

(51) Int. Cl. G06T 7/223; G08B 21/04; G06K 9/00; G06T 7/00; G06T 7/246

(52) U.S. Cl. CPC G06T 7/223; G08B 21/043; G06T 7/248; G06K 9/00342; G06T 7/0002; G08B 21/0476

(57) ABSTRACT

This disclosure provides a fall detection method, a fall detection apparatus and an electronic device. The apparatus includes a processor configured to: detect persons in image frames; detect persons having a motion displacement exceeding a first predetermined threshold and a deformation exceeding a second predetermined threshold according to a first number of consecutive image frames and take the same as images of first persons; detect persons stayed immobile in the images of the first persons according to a second number of consecutive image frames after the first number of consecutive image frames, and take the same as images of the second persons; and detect static objects in the image frames, and detect whether a fall has occurred according to the static objects and the images of the second persons. This disclosure may improve accuracy of fall detection, and is applicable to multiple scenarios.

### CROSS-REFERENCE TO RELATED APPLICATIONS

This application is based on and hereby claims priority to Chinese Application No. 201811621796.7, filed Dec. 28, 2018, in the State Intellectual Property Office of China, the disclosure of which is incorporated herein by reference.

### TECHNICAL FIELD

This disclosure relates to the field of information technologies, and in particular to a fall detection method, a fall detection apparatus and an electronic device.

### BACKGROUND

As society ages, consumer demands for fall detection apparatuses have increased rapidly in recent years.

The existing fall detection apparatuses are mainly divided into two types: fall detection apparatuses based on wearable devices, and fall detection apparatuses based on a context-aware system.

In a fall detection apparatus based on a wearable device, fall detection is usually performed by using an accelerometer, and furthermore, other sensors may be used to acquire information of the user, for example, a gyroscope may be used to acquire position information of the user.

In a fall detection apparatus based on a context-aware system, fall is detected by a sensing device provided in the environment. The sensing device may be, for example, a video camera, a floor sensor, an infrared sensor, a microphone, or a pressure sensor.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that an existing camera-based fall detection apparatus has some defects, such as detection accuracy is not high enough; and furthermore, in most cases, it is applicable to fall detection in an indoor environment with only one person, so there are many limitations of use.

Embodiments of this disclosure provide a fall detection method, fall detection apparatus and electronic device, in which on the basis of detecting a motion displacement and an action amplitude of a person in a video image, fall of the person is detected with reference to a detection result of a static object, thereby improving accuracy of fall detection; and furthermore, this disclosure may detect complex scenarios where there are relatively more persons, so it is applicable to multiple scenarios.

According to an embodiment of this disclosure, there is provided a fall detection apparatus, a memory and a processor. The processor is configured to detect persons in image frames; in image frames in which persons are detected, detect persons having a motion displacement exceeding a first predetermined threshold and a deformation exceeding a second predetermined threshold according to a first number of consecutive image frames and take them as images of first persons.

The processor is configured to, in the image frames in which persons are detected, detect persons that stayed immobile in the images of the first persons according to a second number of consecutive image frames after the first number of consecutive image frames, and take them as images of second persons.

The processor is configured to, in the image frames in which persons are detected, detect static objects in the image frames, and detect whether a fall has occurred according to the static objects and the images of the second persons that are detected.

According to an embodiment of this disclosure, there is provided a fall detection method.

The method includes detecting persons in image frames; in image frames in which persons are detected, detecting persons having a motion displacement exceeding a first predetermined threshold and a deformation exceeding a second predetermined threshold according to a first number of consecutive image frames, and taking them as images of first persons; in the image frames in which persons are detected, detecting persons that stayed immobile in the images of the first persons according to a second number of consecutive image frames after the first number of consecutive image frames, and taking them as images of second persons; and in the image frames in which persons are detected, detecting static objects in the image frames, and detecting whether a fall has occurred according to the static objects and the images of the second persons.

According to an embodiment of this disclosure, there is provided an electronic device, including the fall detection apparatus as described above.

By way of example, an advantage of the embodiments of this disclosure exists in that on the basis of detecting a motion displacement and an action amplitude of a person in a video image, fall of the person is detected with reference to a detection result of a static object, thereby improving accuracy of fall detection; and furthermore, this disclosure may detect complex scenarios in which there are relatively more persons, so it is applicable to multiple scenarios.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, blocks or components but does not preclude the presence or addition of one or more other features, integers, blocks, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced. Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a flowchart of the fall detection method according to an embodiment;

FIG. 2 is a schematic diagram of a block of motion detection according to an embodiment;

FIG. 3 is a schematic diagram of an image frame, a foreground image and a motion history image at a time t according to an embodiment;

FIG. 4 is a schematic diagram of a block of deformation detection according to an embodiment;

FIG. 5 is a schematic diagram of an outer bounding box of a person of an image frame according to an embodiment;

FIG. 6 is a schematic diagram of an outer bounding box of a person of an image frame according to an embodiment;

FIG. 7 is a schematic diagram of block 103 according to an embodiment;

FIG. 8 is a schematic diagram of block 104 according to an embodiment;

FIG. 9 is a flowchart of the fall detection method according to an embodiment;

FIG. 10 is a schematic diagram of the fall detection apparatus according to an embodiment;

FIG. 11 is a schematic diagram of the second detecting unit according to an embodiment;

FIG. 12 is a schematic diagram of the fifth detecting unit according to an embodiment;

FIG. 13 is a schematic diagram of the sixth detecting unit according to an embodiment;

FIG. 14 is a schematic diagram of the third detecting unit according to an embodiment;

FIG. 15 is a schematic diagram of the fourth detecting unit according to an embodiment; and

FIG. 16 is a schematic diagram of a structure of the electronic device according to an embodiment.

### DETAILED DESCRIPTION OF THE DISCLOSURE

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

### Embodiment 1

Embodiment 1 provides a fall detection method.

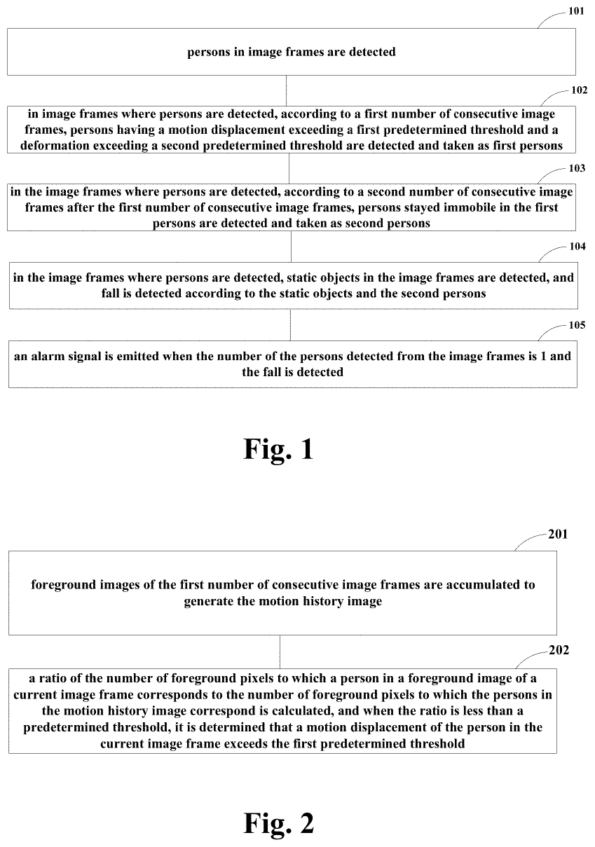

FIG. 1 is a flowchart of the fall detection method of this embodiment. As shown in FIG. 1, the fall detection method includes:

block 101: persons in image frames are detected;

block 102: in image frames where persons are detected, according to a first number of consecutive image frames, persons having a motion displacement exceeding a first predetermined threshold and a deformation exceeding a second predetermined threshold are detected and taken as first persons;

block 103: in the image frames where persons are detected, according to a second number of consecutive image frames after the first number of consecutive image frames, persons stayed immobile in the first persons are detected and taken as second persons; and

block 104: in the image frames where persons are detected, static objects in the image frames are detected, and fall is detected according to the static objects and the second persons.

In this embodiment, on the basis of detecting a motion displacement and an action amplitude of a person in a video image, fall of the person is detected with reference to a detection result of a static object, thereby improving accuracy of fall detection; and furthermore, this disclosure may detect complex scenarios where there are relatively more persons, so it is applicable to multiple scenarios.

In this embodiment, the image frames may be from a video captured by a camera in real time manner, or may be from a video stored in a storage device, which is not limited in this embodiment.

In this embodiment, blocks 101-104 may be executed for pixel sets (blob) obtained by preprocessing in the image frames, thereby detecting whether objects to which the pixel sets correspond experience fall of persons. The same object corresponds to a pixel set, wherein pixel clusters to which the same object corresponds in image frames of more than two consecutive image frames belong to the pixel set (blob).

In this embodiment, as shown in FIG. 1, the fall detection method may further include:

block 100: pre-processing the image frames to obtain a pixel set.

In this embodiment, block 100 (not shown) may include a processing of background subtraction and a processing of objection tracking.

In the processing of background subtraction in this embodiment, a foreground image may be detected from the image frames, and whether a foreground pixel cluster in the foreground images corresponds to a static object or a moving object is determined.

In this embodiment, reference may be made to the related art for a method used in the processing of background subtraction. For example, the processing of background subtraction may be executed by using a dual foreground method. However, this embodiment is not limited thereto, and other methods may also be used to execute the processing of background subtraction.

In the processing of object tracking of this embodiment, foreground pixel clusters detected from neighboring image frames in the processing of background subtraction may be associated, and foreground pixel clusters associated with each other in the neighboring image frames are deemed as corresponding to the same static object or moving object.

For example, multiple foreground pixel clusters A1, . . . , Ai, . . . An1 are detected from image frame 1, and multiple foreground pixel clusters B1, . . . , Bj, . . . Bn2 are detected from image frame 2. The image frame 1 and image frame 2 are two image frames temporally neighboring one after another. n1, n2, i, j being all natural numbers, 1≤i≤n1, and 1≤j≤n2.

A similarity between the foreground pixel cluster Ai and the foreground pixel cluster Bj is expressed as Similarity (A, B), which may calculate Similarity(Ai, Bj) according to formula (1) below:

$$Similarity ( Ai , Bj ) = \frac{intersection ( Ai , Bj )}{union ( Ai , Bj )} \qquad ( 1 )$$

where, intersection (Ai,Bj) denotes the number of overlapped pixels between the foreground pixel cluster Ai and the foreground pixel cluster Bj, and union(Ai, Bj) denotes a total number of pixels of the foreground pixel cluster Ai and the foreground pixel cluster Bj.

In this embodiment, the larger the Similarity (Ai, Bj), the higher the probability that the foreground pixel cluster Ai and the foreground pixel cluster Bj correspond to the same object. When the Similarity (Ai, Bj) satisfies a predetermined condition, the foreground pixel cluster Ai is associated with the foreground pixel cluster Bj, hence, it is determined that the foreground pixel cluster Ai and the foreground pixel cluster Bj correspond to the same object, that is, the foreground pixel cluster Ai and the foreground The pixel cluster Bj belong to the same pixel set (blob).

In this embodiment, for at least three consecutive image frames, the above-described block of object tracking may be performed for every two neighboring image frames, thereby being able to detect pixel clusters in the at least three consecutive image frames corresponding to the same object.

In this embodiment, with block 100, information on pixel sets (blob) to the objects in the multiple image frames correspond may be obtained. Furthermore, pixel clusters belonging to the same pixel set may be granted the same mark information.

Furthermore, in this embodiment, block 100 is not a necessary processing of this embodiment. For example, after information on pixel sets is obtained by preprocessing the image frames, the information on pixel sets and the image frames may be stored, and blocks 101-104 are implemented for the stored information on pixel sets and image frames are processed.

In block 101 of this embodiment, human body silhouettes in the image frames may be detected based on a classifier, so as to detect the persons in the image frames, thereby being able to determine whether the object to the pixel cluster of the image frames corresponds is a person. For example, for a certain pixel cluster of a current image frame, whether the pixel cluster is a human body silhouette may be detected by using a classifier, and if it is a human body silhouette, the object to which the pixel cluster corresponds is deemed as a person; otherwise, the object to which the pixel cluster corresponds is not taken as a person.

In this embodiment, for the method for detecting based on the classifier, for example, a self-trained support vector machine (SVM) classifier based on histograms of oriented gradients (HOG) information, may be used. Furthermore, detection may also be performed in conjunction with a deep learning method, such as single shot multiBox detector (SSD)+MobileNet, or faster regional convolutional neural network (faster RCNN)+ResNet.

It should be noted that one image frame may include more than one pixel clusters, and thus, the image frame may include more than one persons. The processing in blocks 102-103 may be performed for all persons in this embodiment, hence, it is possible to detect fall of multiple persons.

In block 101 of this embodiment, pixel clusters detected as persons may be marked, and different persons may correspond to different marks.

In block 102 of the embodiment, in the image frames in which persons are detected, according to a first number of consecutive image frames, persons having a motion displacement exceeding the first predetermined threshold and a deformation exceeding the second predetermined threshold are detected and taken as first persons.

In this embodiment, block 102 may include processing of motion detection and processing of deformation detection.

In the processing of motion detection in this embodiment, the persons having a motion displacement exceeding the first predetermined threshold may be detected according to motion history image (MHI) of the first number of consecutive image frames.

FIG. 2 is a schematic diagram of the processing of motion detection. As shown in FIG. 2, the processing of motion detection may include:

block 201: foreground images of the first number of consecutive image frames are accumulated to generate the motion history image; and

block 202: a ratio of the number of foreground pixels to which a person in a foreground image of a current image frame corresponds to the number of foreground pixels to which the persons in the motion history image correspond is calculated, and when the ratio is less than a predetermined threshold, it is determined that a motion displacement of the person in the current image frame exceeds the first predetermined threshold.

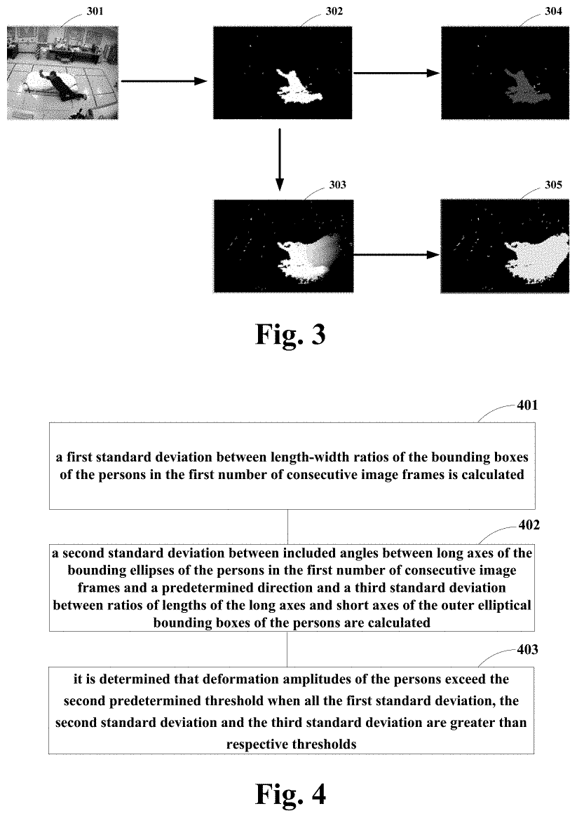

FIG. 3 is a schematic diagram of an image frame, a foreground image and a motion history image at a time t. An implementation of the processing of motion detection will be described below with reference to FIG. 3.

In the image frames in which persons are detected, N consecutive image frames are selected, a pixel with coordinates (x, y) in an image frame F(t) at the time t is denoted as F(x, y, t), and a pixel with coordinates (x, y) in a foreground image D(t) of the image frames at the time t is denoted as D(x, y, t), the foreground image being able to be obtained in, for example, a background subtraction method. The image frame F(t) at the time t is as shown by 301 in FIG. 3, and denotes the current image frame; and the foreground image D(t) of the image frame at the time t is as shown by 302 in FIG. 3.

The motion history image to which the time t corresponds may be denoted by H_{τ}, which may be obtained by accumulating foreground images of N1 image frames prior to the time t, where, N1 is the first number, and a duration period of the N1 image frames is τ, 1≤N1≤N; and the pixel with coordinates (x, y) in the motion history image is expressed as H_{τ}(x, y, t), which, for example, may be obtained through calculating by using formula (2) below:

$${H}_{τ} ( x , y , t ) = \{ \begin{matrix}τ , & D ( x , y , t ) = 1 \\ max ( 0 , {H}_{τ} ( x , y , t - 1 ) - 1 ) , & otherwise\end{matrix} \qquad ( 2 )$$

In the motion history image H_{τ}, pixels of moving objects are more bright, hence, the motion history image H_{τ} may represent a motion trajectory of an object in the image frames within the time period τ. In this embodiment, τ may be, for example, a duration period of 12 image frames, that is, N1 is 12. The motion history image H_{τ} to which time t corresponds is shown by 303 in FIG. 3.

After D(x, y, t) and H_{τ}(x, y, t) are obtained, a motion coefficient Cₘₒₜᵢₒₙ may be calculated for the pixel clusters detected as persons, and the motion coefficient Cₘₒₜᵢₒₙ may be used to quantize motion displacement of the pixel cluster detected as person. For example, the motion coefficient Cₘₒₜᵢₒₙ may be calculated by using formula (3) below:

$${C}_{motion} = \frac{{\sum }_{pixel ( x , y )} D ( x , y , t ) \neq 0}{{\sum }_{pixel ( x , y )} {H}_{τ} ( x , y , t ) \neq 0} \qquad ( 3 )$$

In formula (3), Σ_{pixel(x,y)}D(x,y,t)≠0 denotes the number of foreground pixels to which the pixel clusters detected as a person in the foreground image D(t) of the image frame at the time t correspond, and Σ_{pixel(x,y)}H_{τ}(x,y,t)≠0 denotes the number of foreground pixels to which the pixel cluster detected as the persons in motion history image H_{τ} corresponding to the time t correspond.

According to the above formula (3), 0%≤Cₘₒₜᵢₒₙ≤100%, and the smaller the value of the motion coefficient Cₘₒₜᵢₒₙ, the larger the motion displacement of the person within the time period τ.

In the processing of motion detection of this example, when the motion coefficient Cₘₒₜᵢₒₙ is less than a predetermined threshold T1, it may be determined that the motion displacement of the person of the image frame at time t exceeds the first predetermined threshold.

Furthermore, in this embodiment, it is also possible to perform binarization processing on D(t) and H_{τ}, respectively, and calculate the motion coefficient Cₘₒₜᵢₒₙ for D(t) and H_{τ} after the binarization processing by using the above formula (3). D(t) and H_{τ} after the binarization processing are respectively as shown by 304 and 305 in FIG. 3.

In the processing of deformation detection of this embodiment, the persons having a deformation exceeding the second predetermined threshold may be detected according to outer bounding ellipses and outer rectangular bounding boxes of the persons in the first number of consecutive image frames.

FIG. 4 is a schematic diagram of the processing of deformation detection. As shown in FIG. 4, the processing of deformation detection may include:

block 401: a first standard deviation of length-width ratios of the bounding boxes of the persons in the first number of consecutive image frames is calculated;

block 402: a second standard deviation of included angles between long axes of the bounding ellipses of the persons in the first number of consecutive image frames and a predetermined direction, and a third standard deviation of ratios of lengths of the long axes and short axes of the outer elliptical bounding boxes of the persons are calculated; and

block 403: it is determined that deformation amplitudes of the persons exceed the second predetermined threshold when all the first standard deviation, the second standard deviation and the third standard deviation are greater than respective thresholds.

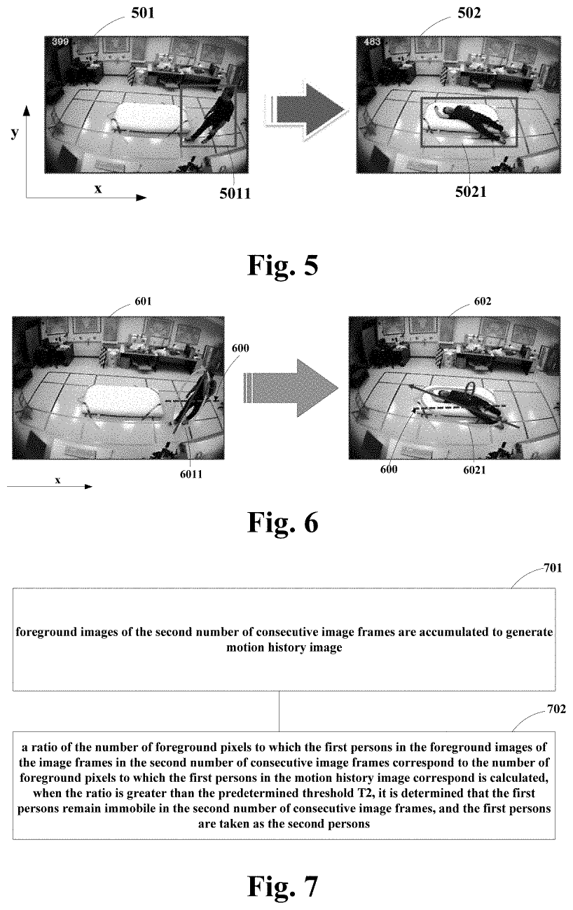

FIG. 5 is a schematic diagram of an outer bounding box of a person of an image frame, and FIG. 6 is a schematic diagram of an outer bounding box of a person of an image frame. An implementation of the processing of deformation detection shall be described below with reference to FIGS. 5 and 6.

In the image frames in which persons are detected, N consecutive image frames are selected, a pixel with coordinates (x, y) in an image frame F(t) at the time t is denoted as F(x, y, t). N1 image frames prior to the time t are taken as the first number of consecutive frames, and a duration period of the N1 image frames is T.

As shown in FIG. 5, in the N1 consecutive image frames, an outer rectangular bounding box of a person in an image frame 501 is 5011, and an outer rectangular bounding box of a person in an image frame 502 is 5021. A length of the bounding box may be the number of pixels parallel to a horizontal direction (i.e. the x direction) of the image frame, and a width of the bounding box may be the number of pixels parallel to a longitudinal direction of the image frame (i.e. the y direction).

As described in block 401 above, for the same person in the N1 consecutive image frames, the length-width ratios of the bounding boxes of the persons in each image frame (i.e. aspect ratios) may be calculated, and the standard deviation of the N1 length-width ratios may be calculated and taken as the first standard deviation.

As shown in FIG. 6, in the N1 consecutive image frames, a circumscribed ellipse bounding box of a person in an image frame 601 is 6011, and a circumscribed ellipse bounding box of a person in another image frame 602 is 6021.

As described in block 402 above, for the same person in the N1 consecutive image frames, the included angle between the long axis of the bounding ellipse of the person in each image frame and the predetermined direction may be calculated, the ratio of the long axis and the short axis of the bounding ellipse of the person may be calculated, a standard deviation of the N1 included angles are calculated and taken as the second standard deviation, and a standard deviation of the N1 length ratios are calculated and taken as the third standard deviation.

The predetermined direction may be a lateral direction of the image frame, as shown by a broken line 600 in FIG. 6, and the included angle is as shown by θ in FIG. 6.

In this embodiment, in the above block 402, the length 2*a of the long axis and the length of the short axis 2*b of the circumscribed ellipse bounding box of the person in the image frames and the included angle θ between the long axis and the predetermined direction may be calculated in a manner as below:
assuming that the pixel with coordinates (x, y) in the foreground image D(t) of the image frame at time t is denoted as D(x, y, t), and a moment of the person in the foreground image D(t) is denoted as m_{pq}, m_{pq}, the calculation formula is, for example, as formula (4) below:

m_{pq}=∫_{-∞}^{+∞}∫_{-∞}^{+∞}x^{p}y^{q}D(x,y,t)dxdy (4)

where, both p and q are positive integers or zero, i.e. p,q=0, 1, 2, . . . .

Central coordinates x̅, y̅ of the elliptical bounding box of the person are

$$\overline{x} = \frac{{m}_{10}}{{m}_{00}} , \overline{y} = \frac{{m}_{01}}{{m}_{00}} ,$$

respectively; where, m₀₀ denotes a zero order moment, and m₁₀ and m₀₁ denote first order moments.

The coordinates x̅, y̅ are used to calculate a central moment μ_{pq}. For example, μ_{pq} is calculated by using formula (5) below:

μ_{pq}=∫_{-∞}^{+∞}∫_{-∞}^{+∞}(x−x̅)^{p}(y−y̅)^{q}D(x,y,t)dxdy (5)

An included angle θ between a long axis of the elliptical bounding box and a predetermined direction may be calculated according to a first order central moment and second order central moments. For example, θ is calculated by using formula (6) below:

$$θ = \frac{1}{2} arc tan ( \frac{2 {μ}_{11}}{{μ}_{20} - {μ}_{02}} ) \qquad ( 6 )$$

where, μ₁₁ denotes the first order central moment, and μ₂₀ and μ₀₂ denote the second order central moments.

In this embodiment, a maximum value Iₘₐₓ and a minimum value Iₘᵢₙ of moments of inertia may be calculated according a covariance matrix J of the central moment, and then a length a of a semi-axis of the long axis and a length b of a semi-axis of the short axis of the elliptical bounding box are calculated according to Iₘₐₓ and Iₘᵢₙ.

For example, the covariance matrix J of the central moment is expressed as formula (7) below:

$$J = ( \begin{matrix}{μ}_{20} & {μ}_{11} \\ {μ}_{11} & {μ}_{02}\end{matrix} ) \qquad ( 7 )$$

The maximum value Iₘₐₓ and the minimum value Iₘᵢₙ of the moments of inertia are calculated by using formulae (8) and (9) below:

$$\begin{matrix}{I}_{min} = \frac{{μ}_{20} + {μ}_{02} - \sqrt{{( {μ}_{20} - {μ}_{02} )}^{2} + 4 {μ}_{11}^{2}}}{2} & ( 8 ) \\ {I}_{max} = \frac{{μ}_{20} + {μ}_{02} + \sqrt{{( {μ}_{20} - {μ}_{02} )}^{2} + 4 {μ}_{11}^{2}}}{2} & ( 9 )\end{matrix}$$

And a and b are calculated by using formulae (10) and (11) below:

$$\begin{matrix}a = {{( \frac{4}{π} )}^{\frac{1}{4}} [ \frac{{( {I}_{max} )}^{3}}{{I}_{min}} ]}^{\frac{1}{8}} & ( 10 ) \\ b = {{( \frac{4}{π} )}^{\frac{1}{4}} [ \frac{{( {I}_{min} )}^{3}}{{I}_{max}} ]}^{\frac{1}{8}} & ( 11 )\end{matrix}$$

In the above block 403, when the first standard deviation, the second standard deviation and the third standard deviation are all greater than the respective corresponding thresholds, it is determined that the deformation amplitude of the person exceeds a second predetermined threshold, that is, the deformation amplitude of the person is relatively large.

In blocks 401-403 of this embodiment, as the rectangular bounding boxes and the elliptical bounding boxes are taken into account, the detection of the deformation of the persons is more accurate.

According to this embodiment, for the first number of consecutive image frames, when the motion displacement of the pixel set to which a person corresponds exceeds the first predetermined threshold and the deformation exceeds the second predetermined threshold, the person is detected as the first person, who is considered as being more likely to fall. Furthermore, a pixel set to which the first person corresponds may be marked.

In block 103 of this embodiment, for the second number of consecutive image frames after the first number of consecutive image frames, whether the first persons stayed immobile in the second number of consecutive image frames is detected, and the first persons are detected as second persons if they remain immobile. Hence, a case where a person is unable to move after fall may be detected.

FIG. 7 is a schematic diagram of block 103 of this embodiment. As shown in FIG. 7, block 103 may include:

block 701: foreground images of the second number of consecutive image frames are accumulated to generate motion history image; and

block 702: a ratio of the number of foreground pixels to which the first persons in the foreground images of each image frame in the second number of consecutive image frames correspond to the number of foreground pixels to which the first persons in the motion history image correspond is calculated, when the ratio is greater than the predetermined threshold T2, it is determined that the first persons remain immobile in the second number of consecutive image frames, and the first persons are taken as the second persons.

In this embodiment, when the first persons are detected at time t, N2 consecutive images starting from a time t+1 may be taken as the second number of consecutive image frames.

In the block 701 of this embodiment, reference may be made to the above description of block 201 for a method for generating the motion history image (MHI).

In block 702 of this embodiment, the motion coefficient Cₘₒₜᵢₒₙ of the pixel cluster to which the first persons correspond in the second number of consecutive image frames may be detected according to the motion history image, and if the motion coefficient Cₘₒₜᵢₒₙ is greater than a predetermined threshold T2, it is determined that the first persons move a small distance in the second number of consecutive image frames, even stay almost immobile, and the first persons are determined as second persons, which are considered as being more likely to fall.

Furthermore, in block 702, when the calculated motion coefficient Cₘₒₜᵢₒₙ is not greater than the predetermined threshold T2, the marks of the first persons may be removed, that is, it is determined that the persons have relatively large distances to move in the second number of consecutive image frames, hence, the persons are less likely to fall, and the persons are no longer marked as the first persons.

In block 104 of this embodiment, in the image frames in which the persons are detected, the static objects in the image frames are detected, and if the detected static objects match the second persons detected in block 103, it is determined that the second persons fall. Hence, the accuracy of the fall detection may be improved, and a rate of false detection may be lowered.

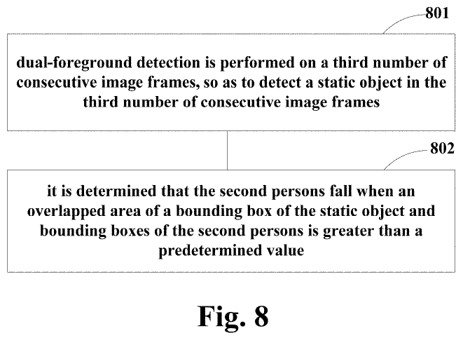

FIG. 8 is a schematic diagram of block 104 of this embodiment. As shown in FIG. 8, block 104 may include:

block 801: dual-foreground detection is performed on a third number of consecutive image frames, so as to detect a static object in the third number of consecutive image frames; and

block 802: it is determined that the second persons fall when an overlapped area of a bounding box of the static object and bounding boxes of the second persons is greater than a predetermined value.

In block 801 of this embodiment, a last image frame in the third number of consecutive image frames may be later than a last image frame in the second number of consecutive image frames. In one implementation, N3 consecutive image frames may be taken as a unit, the dual-foreground detection may be performed on the units in a chronological order, and a detection result of a static object of a unit is taken as a detection result of the static object of the third number of consecutive image frames, the unit being a unit having a last image frame located after the last image frame in the second number of consecutive image frames.

For example, a first image frame unit includes image frames with sequence numbers S1˜S_{N3}, a second image frame unit includes image frames with sequence numbers S_{N3+1}˜S_{2*N3}, and a third image frame unit includes image frames with sequence numbers S_{2*N3+1}˜S_{3*N3}, and static object detection may be sequentially performed on the first image frame unit, the second image frame unit, and the third image frame unit; a sequence number of a last image frame in the second number of consecutive image frames is, for example, S_{3*N3-3}, that is, the last image frame S_{3*N3} in the third image frame unit is later than S_{3*N3-3}, therefore, in block 801, static object detection is performed on the third image frame unit, and a result of the detection is taken as the detection result of the static object of the third number of consecutive image frames.

In block 801 of this embodiment, a method for performing the dual-foreground detection may be, for example, obtaining first foreground detection results of the image frames by using rapidly updated backgrounds, obtaining second foreground detection results of the image frames by using slowly updated backgrounds, and detecting static objects in the image frames based on correspondences in Table 1 below.

Table 1 below is an example of the correspondences between the first foreground detection results and the second foreground detection result and different objects in the video image frame.

TABLE 1

| | | First foreground detection results | |
|---|---|---|---|
| Image frames | | Foreground | Background |
| Second | Foreground | Moving object | Static object |
| foreground | Background | Uncovered | Background of |
| detection results | | background | scenario |

As shown in Table 1 above, the object detected as a background in the first foreground detection result and detected as a foreground in the second foreground detection result is detected as a static object in the image frame.

In block 802 of this embodiment, a bounding box of the static object detected in block 801 may be compared with the bounding boxes of the second persons detected in block 103, and it is determined that the second persons fall when an overlapped area of them is greater than a predetermined value. For example, it is detected in block 801 that there are three static objects in the third number of consecutive video frames, and it is detected in block 103 that there are two second persons in the second number of consecutive video frames. The number of pixels of an overlapped area of the bounding box of the second person and the bounding box of the static object is greater than the predetermined value; hence, it is determined that the second persons fall. Furthermore, another second person is determined as having not fallen, and the mark of the second person may be removed.

In this embodiment, as shown in FIG. 1, the method may further include:

block 105: an alarm signal is emitted when the number of the persons detected from the image frames in block 101 is 1 and fall is detected in block 104.

Thus, in a scenario where there is only one person, if a serious fall occurs, an alarm signal may be emitted in time to seek help from others. The alarm signal may be, for example, a signal emitting alarm information, the alarm information being, for example, a sound, and/or an image, and/or a word.

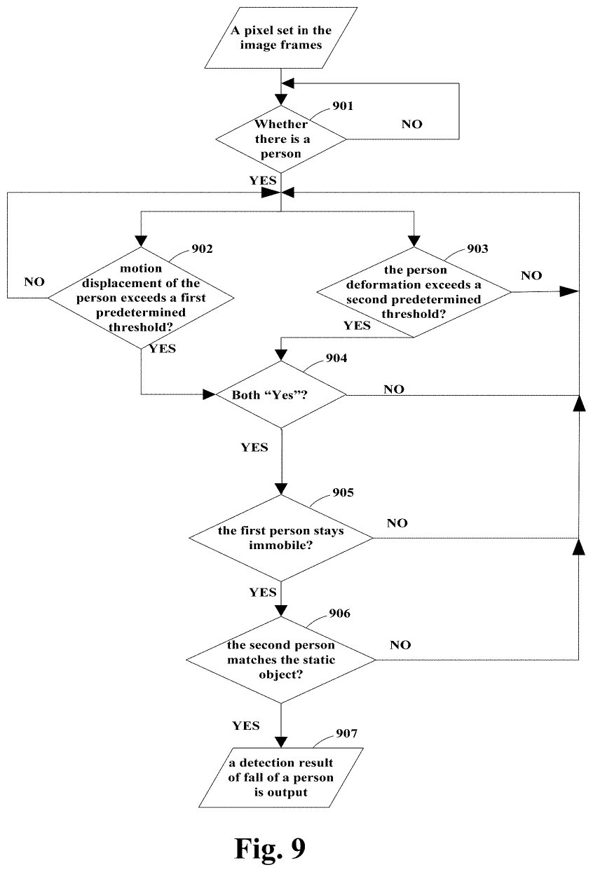

FIG. 9 is a flowchart of the fall detection method of this disclosure, in which description shall be given to a pixel set (blob) in image frames. As shown in FIG. 9, the process of fall detection includes:

block 901: it is detected whether there is a person in the image frames, such as based on a classifier, and detecting whether a pixel cluster to which the pixel set in the image frames correspond is a human body silhouette; if a result of block 901 is “YES”, executing block 902, and if the result of block 901 is “NO”, turning back to block 901 to determine a next image frame for performing person detection;

block 902: according to the first number of consecutive image frames, it is detected whether a motion displacement of the person exceeds a first predetermined threshold, if a result is “Yes”, executing block 904, and if the result is “No”, turning back to blocks 902 and 903 to perform detection on a next group of the first number of consecutive image frames;

block 903: it is detected whether the person deformation exceeds a second predetermined threshold according to the first number of consecutive image frames, and if a result is “Yes”, executing block 904, and if the result is “No”, turning back to blocks 902 and 903 to detect the next group of the first number of consecutive image frames;

block 904: it is determined whether block 902 and block 903 are both “Yes”, if a determination result is “Yes”, it is deemed that the person is the first person, and executing block 905, and if the determination result is “No”, turning back to blocks 902 and 903 to detect the next group of the first number of consecutive image frames;

block 905: it is determined whether the first person stays immobile in the second number of consecutive image frames, if a determination result is “Yes”, it is deemed that first person is the second person, and executing block 906, and if the determination result is “No”, turning back to blocks 902 and 903 to detect the next group of the first number of consecutive image frames; and

block 906: it is determined whether the second person matches the static object in the image frames, if a determination result is “Yes”, executing block 907 and in block 907, a detection result of fall of a person is output, and if the determination result is “No”, turning back to blocks 902 and 903 to detect the next group of the first number of consecutive image frames.

According to this embodiment, on the basis of detecting a motion displacement and an action amplitude of a person in a video image, fall of the person is detected with reference to a detection result of a static object, thereby improving accuracy of fall detection and reducing false detection; and furthermore, this disclosure may detect complex scenarios where there are relatively more persons, so it is applicable to multiple scenarios. Moreover, in a scenario where there is only one person, when a fall is detected, an alarm signal may be emitted in time to seek help from others.

### Embodiment 2

Embodiment 2 provides a fall detection apparatus. As a principle of the apparatus for solving problems is similar to that of the method in Embodiment 1, reference may be made to the implementation of the method in Embodiment 1 for implementation of the apparatus, with identical contents being not going to be described herein any further.

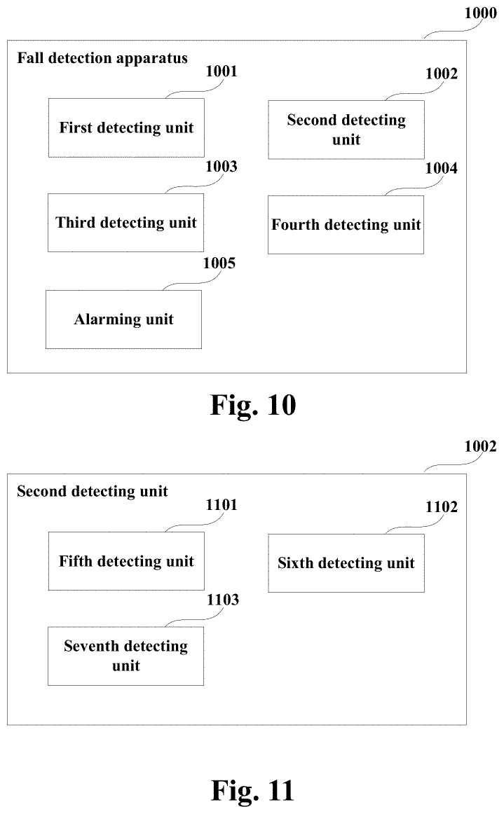

FIG. 10 is a schematic diagram of the fall detection apparatus. As shown in FIG. 10, a fall detection apparatus 1000 includes:

a first detecting unit 1001 configured to detect persons in image frames;

a second detecting unit 1002 configured to, in image frames where persons are detected, according to a first number of consecutive image frames, detect persons having a motion displacement exceeding a first predetermined threshold and a deformation exceeding a second predetermined threshold and take them as first persons;

a third detecting unit 1003 configured to, in the image frames where persons are detected, according to a second number of consecutive image frames after the first number of consecutive image frames, detect persons stayed immobile in the first persons and take them as second persons; and

a fourth detecting unit 1004 configured to, in the image frames where persons are detected, detect static objects in the image frames, and detect fall according to the static objects and the second persons.

Furthermore, as shown in FIG. 10, the apparatus 1000 includes:

an alarming unit 1005 configured to emit an alarm signal when the number of the persons detected by the first detecting unit 1002 from the image frames is 1 and the fourth detecting unit 1004 detects the fall.

In this embodiment, the first detecting unit 1001 detects human body silhouettes in the image frames based on a classifier, so as to detect the persons in the image frames.

FIG. 11 is a schematic diagram of the second detecting unit of this embodiment; wherein the second detecting unit 1002 includes:

a fifth detecting unit 1101 configured to detect the persons having a motion displacement exceeding the first predetermined threshold according to motion history image in the first number of consecutive image frames;

a sixth detecting unit 1102 configured to detect the persons having a deformation exceeding the second predetermined threshold according to outer bounding ellipses and outer bounding boxes of the persons in the first number of consecutive image frames; and

a seventh detecting unit 1103 configured to detect the persons having a motion displacement exceeding the first predetermined threshold and a deformation exceeding the second predetermined threshold.

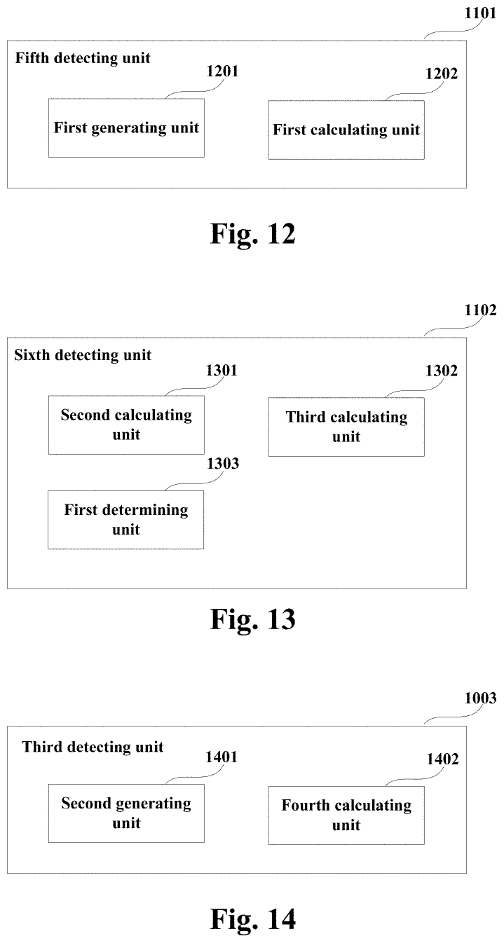

FIG. 12 is a schematic diagram of the fifth detecting unit of this embodiment; wherein the fifth detecting unit may include:

a first generating unit 1201 configured to accumulate foreground images of the first number of consecutive image frames to generate the motion history image; and

a first calculating unit 1202 configured to calculate a ratio of the number of foreground pixels to which a person in a foreground image of a current image frame corresponds to the number of foreground pixels to which the persons in the motion history image correspond, and when the ratio is less than a predetermined threshold, determine that a motion displacement of the person in the current image frame exceeds the first predetermined threshold.

FIG. 13 is a schematic diagram of the sixth detecting unit of this embodiment; wherein the sixth detecting unit 1102 includes:

a second calculating unit 1301 configured to calculate a first standard deviation between length-width ratios of the bounding boxes of the persons in the first number of consecutive image frames;

a third calculating unit 1302 configured to calculate a second standard deviation between included angles between long axes of the bounding ellipses of the persons in the first number of consecutive image frames and a predetermined direction and a third standard deviation between ratios of lengths of the long axes and short axes of the outer elliptical bounding boxes of the persons; and

a first determining unit 1303 configured to determine that deformation amplitudes of the persons exceed the second predetermined threshold when all the first standard deviation, the second standard deviation and the third standard deviation are greater than respective thresholds.

FIG. 14 is a schematic diagram of the third detecting unit of this embodiment; wherein the third detecting unit 1003 includes:

a second generating unit 1401 configured to accumulate foreground images of the second number of consecutive image frames to generate motion history image; and

a fourth calculating unit 1402 configured to calculate a ratio of the number of foreground pixels to which the first persons in the foreground images of the image frames in the second number of consecutive image frames correspond to the number of foreground pixels to which the first persons in the motion history image correspond, when the ratio is greater than the predetermined threshold T2, determine that the first persons remain immobile in the second number of consecutive image frames, and take the first persons as the second persons.

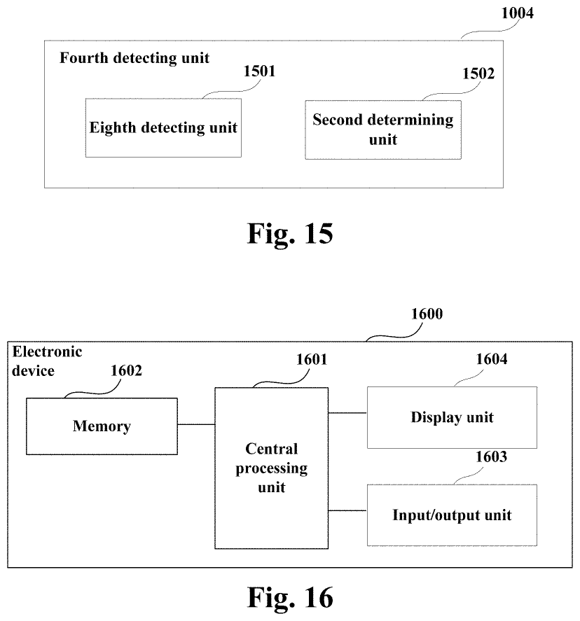

FIG. 15 is a schematic diagram of the fourth detecting unit of this embodiment; wherein the fourth detecting unit includes:

an eighth detecting unit 1501 configured to perform dual-foreground detection on a third number of consecutive image frames, so as to detect a static object in the third number of consecutive image frames, a last image frame in the third number of consecutive image frames being later than a last image frame in the second number of consecutive image frames; and

a second determining unit 1502 configured to determine that the second persons fall when an overlapped area of a bounding box of the static object and bounding boxes of the second persons is greater than a predetermined value.

Reference may be made to corresponding blocks in Embodiment 1 for detailed description of the units in this embodiment, which shall not be described herein any further.

According to this embodiment, on the basis of detecting a motion displacement and an action amplitude of a person in a video image, fall of the person is detected with reference to a detection result of a static object, thereby improving accuracy of fall detection and reducing false detection; and furthermore, this disclosure may detect complex scenarios where there are relatively more persons, so it is applicable to multiple scenarios. Moreover, in a scenario where there is only one person, when a fall is detected, an alarm signal may be emitted in time to seek help from others.

### Embodiment 3

Embodiment 3 provides an electronic device. As a principle of the electronic device for solving problems is similar to that of the apparatus 1000 in Embodiment 2, reference may be made to the implementation of the apparatus 1000 in Embodiment 2 for implementation of the electronic device, with identical contents being not going to be described herein any further.

FIG. 16 is a schematic diagram of a structure of the electronic device of the embodiment of this disclosure. As shown in FIG. 16, an electronic device 1600 may include a central processing unit (CPU) 1601 and a memory 1602, the memory 1602 being coupled to the central processing unit 1601. The memory 1602 may store various data, and furthermore, it may store a program for data processing, and execute the program under control of the central processing unit 1601.

In one implementation, the functions of the fall detection apparatus 1000 may be integrated into the central processing unit 1601, wherein the central processing unit 1601 may be configured to carry out the fall detection method described in Embodiment 1.

The central processing unit 1601 may be configured to perform control, so that the electronic device 1600 carries out the following method:

detecting persons in image frames;

in image frames where persons are detected, according to a first number of consecutive image frames, detecting persons having a motion displacement exceeding a first predetermined threshold and a deformation exceeding a second predetermined threshold and taking them as first persons;

in the image frames where persons are detected, according to a second number of consecutive image frames after the first number of consecutive image frames, detecting persons stayed immobile in the first persons and taking them as second persons; and

in the image frames where persons are detected, detecting static objects in the image frames, and detecting fall according to the static objects and the second persons.

In this embodiment, the central processing unit 1601 may be configured to perform control, so that the electronic device 1600 carries out the following method:

detecting human body silhouettes in the image frames based on a classifier, so as to detect the persons in the image frames.

In this embodiment, the central processing unit 1601 may be configured to perform control, so that the electronic device 1600 carries out the following method:

detecting the persons having a motion displacement exceeding the first predetermined threshold according to motion history image in the first number of consecutive image frames; and

detecting the persons having a deformation exceeding the second predetermined threshold according to outer bounding ellipses and outer bounding boxes of the persons in the first number of consecutive image frames;

In this embodiment, the central processing unit 1601 may be configured to perform control, so that the electronic device 1600 carries out the following method:

accumulating foreground images of the first number of consecutive image frames to generate the motion history image; and

calculating a ratio of the number of foreground pixels to which a person in a foreground image of a current image frame corresponds to the number of foreground pixels to which the persons in the motion history image correspond, and when the ratio is less than a predetermined threshold, determining that a motion displacement of the person in the current image frame exceeds the first predetermined threshold.

In this embodiment, the central processing unit 1601 may be configured to perform control, so that the electronic device 1600 carries out the following method:

calculating a first standard deviation between length-width ratios of the bounding boxes of the persons in the first number of consecutive image frames;

calculating a second standard deviation between included angles between long axes of the bounding ellipses of the persons in the first number of consecutive image frames and a predetermined direction and a third standard deviation between ratios of lengths of the long axes and short axes of the outer elliptical bounding boxes of the persons; and

determining that deformation amplitudes of the persons exceed the second predetermined threshold when all the first standard deviation, the second standard deviation and the third standard deviation are greater than respective thresholds.

In this embodiment, the central processing unit 1601 may be configured to perform control, so that the electronic device 1600 carries out the following method:

accumulating foreground images of the second number of consecutive image frames to generate motion history image; and

calculating a ratio of the number of foreground pixels to which the first persons in the foreground images of the image frames in the second number of consecutive image frames correspond to the number of foreground pixels to which the first persons in the motion history image correspond, when the ratio is greater than the predetermined threshold T2, determining that the first persons remain immobile in the second number of consecutive image frames, and taking the first persons as the second persons.

In this embodiment, the central processing unit 1601 may be configured to perform control, so that the electronic device 1600 carries out the following method:

performing dual-foreground detection on a third number of consecutive image frames, so as to detect a static object in the third number of consecutive image frames, a last image frame in the third number of consecutive image frames being later than a last image frame in the second number of consecutive image frames; and

determining that the second persons fall when an overlapped area of a bounding box of the static object and bounding boxes of the second persons is greater than a predetermined value.

In this embodiment, the central processing unit 1601 may be configured to perform control, so that the electronic device 1600 carries out the following method:

emitting an alarm signal when the number of the persons detected by the first detecting unit from the image frames is 1 and the fourth detecting unit detects the fall.

In another implementation, the above apparatus 1000 and the central processing unit 1601 may be configured separately; for example, the apparatus 1000 may be configured as a chip connected to the central processing unit 1601, and the functions of the apparatus 1000 are executed under control of the central processing unit 1601.

Furthermore, as shown in FIG. 16, the electronic device 1600 may include an input/output unit 1603, and a display unit 1604, etc.; wherein functions of the above components are similar to those in the relevant art, which shall not be described herein any further. It should be noted that the electronic device 1600 does not necessarily include all the parts shown in FIG. 16, and furthermore, the electronic device 1600 may include parts not shown in FIG. 16, and the relevant art may be referred to.

According to this embodiment, on the basis of detecting a motion displacement and an action amplitude of a person in a video image, fall of the person is detected with reference to a detection result of a static object, thereby improving accuracy of fall detection and reducing false detection; and furthermore, this disclosure may detect complex scenarios where there are relatively more persons, so it is applicable to multiple scenarios. Moreover, in a scenario where there is only one person, when a fall is detected, an alarm signal may be emitted in time to seek help from others.

An embodiment of the present disclosure provides a computer storage medium, including a computer readable program code, which will cause a fall detection apparatus or an electronic device to carry out the fall detection method as described in Embodiment 1.

An embodiment of the present disclosure provides a computer readable program code, which, when executed in a fall detection apparatus or an electronic device, will cause the fall detection apparatus or the electronic device to carry out the fall detection method as described in Embodiment 1.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or blocks as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIGS. 10-15 may either correspond to software modules of procedures of a computer program, or correspond to hardware modules. Such software modules may respectively correspond to the blocks shown in FIGS. 1 and 7. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 10-15 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIGS. 10-15 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

Following implementations are further provided in this disclosure.

Supplement 1. A fall detection apparatus, including:

a first detecting unit configured to detect persons in image frames;

a second detecting unit configured to, in image frames where persons are detected, according to a first number of consecutive image frames, detect persons having a motion displacement exceeding a first predetermined threshold and a deformation exceeding a second predetermined threshold and take them as first persons;

a third detecting unit configured to, in the image frames where persons are detected, according to a second number of consecutive image frames after the first number of consecutive image frames, detect persons stayed immobile in the first persons and take them as second persons; and

a fourth detecting unit configured to, in the image frames where persons are detected, detect static objects in the image frames, and detect fall according to the static objects and the second persons.

Supplement 2. The apparatus according to supplement 1, wherein, the first detecting unit detects human body silhouettes in the image frames based on a classifier, so as to detect the persons in the image frames.

Supplement 3. The apparatus according to supplement 1, wherein the second detecting unit includes:

a fifth detecting unit configured to detect the persons having a motion displacement exceeding the first predetermined threshold according to motion history image in the first number of consecutive image frames;

a sixth detecting unit configured to detect the persons having a deformation exceeding the second predetermined threshold according to outer bounding ellipses and outer bounding boxes of the persons in the first number of consecutive image frames; and

a seventh detecting unit configured to detect the persons having a motion displacement exceeding the first predetermined threshold and a deformation exceeding the second predetermined threshold.

Supplement 4. The apparatus according to supplement 3, wherein the fifth detecting unit includes:

a first generating unit configured to accumulate foreground images of the first number of consecutive image frames to generate the motion history image; and

a first calculating unit configured to calculate a ratio of the number of foreground pixels to which a person in a foreground image of a current image frame corresponds to the number of foreground pixels to which the persons in the motion history image correspond, and when the ratio is less than a predetermined threshold, determine that a motion displacement of the person in the current image frame exceeds the first predetermined threshold.

Supplement 5. The apparatus according to supplement 3, wherein the sixth detecting unit includes:

a second calculating unit configured to calculate a first standard deviation between length-width ratios of the bounding boxes of the persons in the first number of consecutive image frames;

a third calculating unit configured to calculate a second standard deviation between included angles between long axes of the bounding ellipses of the persons in the first number of consecutive image frames and a predetermined direction and a third standard deviation between ratios of lengths of the long axes and short axes of the outer elliptical bounding boxes of the persons; and

a first determining unit configured to determine that deformation amplitudes of the persons exceed the second predetermined threshold when all the first standard deviation, the second standard deviation and the third standard deviation are greater than respective thresholds.

Supplement 6. The apparatus according to supplement 1, wherein the third detecting unit includes:

a second generating unit configured to accumulate foreground images of the second number of consecutive image frames to generate motion history image; and

a fourth calculating unit configured to calculate a ratio of the number of foreground pixels to which the first persons in the foreground images of the image frames in the second number of consecutive image frames correspond to the number of foreground pixels to which the first persons in the motion history image correspond, when the ratio is greater than the predetermined threshold T2, determine that the first persons remain immobile in the second number of consecutive image frames, and take the first persons as the second persons.

Supplement 7. The apparatus according to supplement 1, wherein the fourth detecting unit includes:

an eighth detecting unit configured to perform dual-foreground detection on a third number of consecutive image frames, so as to detect a static object in the third number of consecutive image frames, a last image frame in the third number of consecutive image frames being later than a last image frame in the second number of consecutive image frames; and

a second determining unit configured to determine that the second persons fall when an overlapped area of a bounding box of the static object and bounding boxes of the second persons is greater than a predetermined value.

Supplement 8. The apparatus according to supplement 1, wherein the apparatus further includes:

an alarming unit configured to emit an alarm signal when the number of the persons detected by the first detecting unit from the image frames is 1 and the fourth detecting unit detects the fall.

Supplement 9. An electronic device, including the fall detection apparatus as claimed in any one of supplements 1-8.

Supplement 10. A fall detection method, including:

detecting persons in image frames;

in image frames where persons are detected, according to a first number of consecutive image frames, detecting persons having a motion displacement exceeding a first predetermined threshold and a deformation exceeding a second predetermined threshold and taking them as first persons;

in the image frames where persons are detected, according to a second number of consecutive image frames after the first number of consecutive image frames, detecting persons stayed immobile in the first persons and taking them as second persons; and

in the image frames where persons are detected, detecting static objects in the image frames, and detecting fall according to the static objects and the second persons.

Supplement 11. The method according to supplement 10, wherein the detecting persons in image frames includes:

detecting human body silhouettes in the image frames based on a classifier, so as to detect the persons in the image frames.

Supplement 12. The method according to supplement 10, wherein the detecting persons having a motion displacement exceeding a first predetermined threshold and a deformation exceeding a second predetermined threshold and taking them as first persons includes:

detecting the persons having a motion displacement exceeding the first predetermined threshold according to motion history image in the first number of consecutive image frames; and

detecting the persons having a deformation exceeding the second predetermined threshold according to outer bounding ellipses and outer bounding boxes of the persons in the first number of consecutive image frames.

Supplement 13. The method according to supplement 12, wherein the detecting the persons having a motion displacement exceeding the first predetermined threshold according to motion history image includes:

accumulating foreground images of the first number of consecutive image frames to generate the motion history image; and

calculating a ratio of the number of foreground pixels to which a person in a foreground image of a current image frame corresponds to the number of foreground pixels to which the persons in the motion history image correspond, and when the ratio is less than a predetermined threshold, determining that a motion displacement of the person in the current image frame exceeds the first predetermined threshold.

Supplement 14. The method according to supplement 12, wherein the detecting the persons having a deformation exceeding the second predetermined threshold according to outer bounding ellipses and outer bounding boxes of the persons includes:

calculating a first standard deviation between length-width ratios of the bounding boxes of the persons in the first number of consecutive image frames;

calculating a second standard deviation between included angles between long axes of the bounding ellipses of the persons in the first number of consecutive image frames and a predetermined direction and a third standard deviation between ratios of lengths of the long axes and short axes of the outer elliptical bounding boxes of the persons; and

determining that deformation amplitudes of the persons exceed the second predetermined threshold when all the first standard deviation, the second standard deviation and the third standard deviation are greater than respective thresholds.

Supplement 15. The method according to supplement 10, wherein the according to a second number of consecutive image frames after the first number of consecutive image frames, detecting persons stayed immobile in the first persons and taking them as second persons, includes:

accumulating foreground images of the second number of consecutive image frames to generate motion history image; and

calculating a ratio of the number of foreground pixels to which the first persons in the foreground images of the image frames in the second number of consecutive image frames correspond to the number of foreground pixels to which the first persons in the motion history image correspond, when the ratio is greater than the predetermined threshold T2, determining that the first persons remain immobile in the second number of consecutive image frames, and taking the first persons as the second persons.

Supplement 16. The method according to supplement 10, wherein the detecting static objects in the image frames according to a result of dual-foreground detection, and detecting fall according to the static objects and the second persons, includes: performing dual-foreground detection on a third number of consecutive image frames, so as to detect a static object in the third number of consecutive image frames, a last image frame in the third number of consecutive image frames being later than a last image frame in the second number of consecutive image frames; and

determining that the second persons fall when an overlapped area of a bounding box of the static object and bounding boxes of the second persons is greater than a predetermined value.

Supplement 17. The method according to supplement 10, wherein the method further includes:

emitting an alarm signal when the number of the persons detected from the image frames is 1 and the fall is detected.

What is claimed is:

1. An apparatus for fall detection, comprising:
a memory; and
a processor coupled to the memory where the processor is configured to:
detect persons in image frames;
in image frames in which persons are detected, detect persons having a motion displacement exceeding a first predetermined threshold and a deformation exceeding a second predetermined threshold according to a first number of consecutive image frames, and take the first number of consecutive image frames detected as images of first persons;
in the image frames in which persons are detected, detect persons that stayed immobile in the images of the first persons according to a second number of consecutive image frames after the first number of consecutive image frames, and take the second number of consecutive image frames detected as images of second persons; and
in the image frames in which persons are detected, detect static objects in the image frames, and detect whether a fall has occurred according to the static objects and the images of the second persons that are detected.

2. The apparatus according to claim 1, wherein,
the processor detects human body silhouettes in the image frames based on a classifier, so as to detect the persons in the image frames.

3. The apparatus according to claim 1, wherein the processor is configured to:
detect the persons having the motion displacement exceeding the first predetermined threshold according to motion history image of the first number of consecutive image frames;
detect the persons having the deformation exceeding the second predetermined threshold according to outer bounding ellipses and outer rectangular bounding boxes of the persons in the first number of consecutive image frames; and
detect the persons having the motion displacement exceeding the first predetermined threshold and the deformation exceeding the second predetermined threshold.

4. The apparatus according to claim 3, wherein the processor is configured to:
accumulate foreground images of the first number of consecutive image frames to generate the motion history image; and
calculate a ratio of a number of foreground pixels to which a person in a foreground image of a current image frame corresponds to a number of foreground pixels to which the persons in the motion history image correspond, and when the ratio is less than a predetermined threshold, determine that a motion displacement of the person in the current image frame exceeds the first predetermined threshold.

5. The apparatus according to claim 3, wherein the processor is configured to:
calculate a first standard deviation of length-width ratios of the bounding boxes of the persons in the first number of consecutive image frames;
calculate a second standard deviation of included angles between long axes of the bounding ellipses of the persons in the first number of consecutive image frames and a predetermined direction and a third standard deviation of ratios of lengths of the long axes and short axes of the outer elliptical bounding boxes of the persons; and
determine that deformation amplitudes of the persons exceed the second predetermined threshold when all the first standard deviation, the second standard deviation and the third standard deviation are greater than respective thresholds.

6. The apparatus according to claim 1, wherein the processor is configured to:
accumulate foreground images of the second number of consecutive image frames to generate motion history image; and
calculate a ratio of a number of foreground pixels to which the first persons in the foreground images of the image frames in the second number of consecutive image frames correspond to a number of foreground pixels to which the first persons in the motion history image correspond, and
when the ratio is greater than the predetermined threshold T2, determine that the first persons that remain immobile in the second number of consecutive image frames, and take the images of the first persons as the images of the second persons.

7. The apparatus according to claim 1, wherein the processor is configured to:
perform dual-foreground detection on a third number of consecutive image frames, so as to detect a static object in the third number of consecutive image frames, a last image frame in the third number of consecutive image frames being later than a last image frame in the second number of consecutive image frames; and
determine that the second persons fall when an overlapped area of a bounding box of the static object and bounding boxes of the second persons is greater than a predetermined value.

8. The apparatus according to claim 1, wherein the apparatus emits an alarm signal when a number of the persons detected in the first number of consecutive image frames from among the image frames is 1 and the fall is detected to have occurred.

9. An electronic device, comprising the fall detection apparatus as claimed in claim 1.

10. A method of fall detection, comprising:
detecting persons in image frames;
in image frames in which persons are detected, detecting persons having a motion displacement exceeding a first predetermined threshold and a deformation exceeding a second predetermined threshold according to a first number of consecutive image frames, and taking the first number of consecutive image frames as images of first persons;
in the image frames in which persons are detected, detecting persons that stayed immobile in the images of the first persons according to a second number of consecutive image frames after the first number of consecutive image frames, and taking the second number of consecutive image frames detected as images of second persons; and
in the image frames in which persons are detected, detecting static objects in the image frames, and detecting whether a fall has occurred according to the static objects and the images of the second persons that are detected.

11. The method according to claim 10, wherein the detecting persons in image frames comprises:
detecting human body silhouettes in the image frames based on a classifier, so as to detect the persons in the image frames.

12. The method according to claim 10, wherein the detecting of persons having the motion displacement exceeding the first predetermined threshold and the deformation exceeding the second predetermined threshold and taking the first number of consecutive image frames detected as the images of the first persons comprises:
detecting the persons having the motion displacement exceeding the first predetermined threshold according to motion history image of the first number of consecutive image frames; and
detecting the persons having the deformation exceeding the second predetermined threshold according to outer bounding ellipses and outer rectangular bounding boxes of the persons in the first number of consecutive image frames.

13. The method according to claim 12, wherein the detecting the persons having the motion displacement exceeding the first predetermined threshold according to motion history image comprises:
accumulating foreground images of the first number of consecutive image frames to generate the motion history image; and
calculating a ratio of a number of foreground pixels to which a person in a foreground image of a current image frame corresponds to a number of foreground pixels to which the persons in the motion history image correspond, and when the ratio is less than a predetermined threshold, determining that a motion displacement of the person in the current image frame exceeds the first predetermined threshold.

14. The method according to claim 12, wherein the detecting the persons having the deformation exceeding the second predetermined threshold according to outer bounding ellipses and outer bounding boxes of the persons comprises:
calculating a first standard deviation of length-width ratios of the bounding boxes of the persons in the first number of consecutive image frames;
calculating a second standard deviation of comprised angles between long axes of the bounding ellipses of the persons in the first number of consecutive image frames and a predetermined direction and a third standard deviation of ratios of lengths of the long axes and short axes of the outer elliptical bounding boxes of the persons; and
determining that deformation amplitudes of the persons exceed the second predetermined threshold when all the first standard deviation, the second standard deviation and the third standard deviation are greater than respective thresholds.

15. The method according to claim 10, wherein the according to the second number of consecutive image frames after the first number of consecutive image frames, detecting the persons that stayed immobile in the images of the first persons and the second number of consecutive image frames as the images of the second persons, comprises:
accumulating foreground images of the second number of consecutive image frames to generate motion history image; and
calculating a ratio of the number of foreground pixels to which the first persons in the foreground images of the image frames in the second number of consecutive image frames correspond to the number of foreground pixels to which the first persons in the motion history image correspond, when the ratio is greater than the predetermined threshold T2, determining that the first persons remain immobile in the second number of consecutive image frames, and taking the first persons as the second persons.

16. The method according to claim 10, wherein the detecting static objects in the image frames according to a result of dual-foreground detection, and detecting whether the fall has occurred according to the static objects and the images of the second persons, comprises:
performing dual-foreground detection on a third number of consecutive image frames, so as to detect a static object in the third number of consecutive image frames, a last image frame in the third number of consecutive image frames being later than a last image frame in the second number of consecutive image frames; and
determining that the second persons fall when an overlapped area of a bounding box of the static object and bounding boxes of the second persons is greater than a predetermined value.

17. The method according to claim 10, wherein the method further comprises:
emitting an alarm signal when a number of the persons detected from the image frames is 1 and the fall is detected.
